(19) United States
(12) Patent Application Publication
(10) Pub. No.: US 2003/0182176 A1
(43) Pub. Date: Sep. 25, 2003

(54) Method of computer-supported assortment optimization and computer system

(76) Inventors: Jurgen Monnerjahn, Neuss (DE); Torsten Derr, Dormagen (DE); Ulrich Scheper, Dormagen (DE)

Correspondence Address: BAYER POLYMERS LLC, 100 BAYER ROAD, PITTSBURGH, PA, 15205, US

(21) Appl. No.: 10/394,354

(22) Filed: Mar. 21, 2003

(30) Foreign Application Priority Data
Mar. 25, 2002 (DE) 10213231.3

(51) Int. Cl. G05B 13/02; G06F 17/60

(52) U.S. Cl. 705/10; 700/28; 700/31

(57) ABSTRACT

A method of computer-supported assortment optimization is described. The method includes: (a) inputting a first property profile for conversion candidates; (b) inputting a second property profile for conversion targets; (c) inputting at least one similarity criterion of at least one property of two comparable products of an assortment; (d) identifying, from the assortment, (i) all conversion candidates which correspond to said first property profile, and (ii) all conversion targets which correspond to said second property profile; (e) testing, for each conversion candidate, each of the conversion targets to determine whether said at least one similarity criterion is fulfilled, thereby identifying a conversion possibility for each conversion candidate; and (f) outputting a set of conversion possibilities for each of said conversion candidates. Also described is a computer program and a computer system which may be used to execute the method of the present invention.

### CROSS REFERENCE TO RELATED PATENT APPLICATION

The present patent application claims the right of priority under 35 U.S.C. §119 (a)-(d) of German Patent Application No. 102 13 231.3, filed Mar. 25, 2002.

### DESCRIPTION OF THE INVENTION

The invention concerns a method of computer-supported assortment optimization and a corresponding computer system and computer program, in particular for optimization of an assortment of chemical products.

Offering a complex product assortment typically requires considerable logistical expenditure, which is associated with corresponding costs. Such complex assortments of goods or services exist in various economic sectors, in particular in the chemical industry.

Because of the large number of type-color combinations of plastics, particularly complex product assortments are involved in this sector, which can cause high complexity related costs. To reduce these complexity costs, the aim is an optimized assortment, to restrict the number of product variants to what is necessary. This optimization of an assortment is in practice not possible manually at justifiable cost, because of the complexity which is caused by the large number of type-color combinations and parameters to be taken into account.

The invention is based on the object of creating a method of computer-supported assortment optimization and a corresponding computer program and computer system.

In accordance with the present invention, there is provided a method of computer-supported assortment optimization comprising the steps of:

(a) inputting a first property profile for conversion candidates;

(b) inputting a second property profile for conversion targets;

(c) inputting at least one similarity criterion of at least one property of two comparable products of an assortment;

(d) identifying, from the assortment,

(i) all conversion candidates which correspond to said first property profile, and

(ii) all conversion targets which correspond to said second property profile;

(e) testing, for each conversion candidate, each of the conversion targets to determine whether said at least one similarity criterion is fulfilled, thereby identifying a conversion possibility for each conversion candidate; and

(f) outputting a set of conversion possibilities for each of said conversion candidates.

In further accordance with the present invention, there is provided a computer system having resources to execute the method of the present invention. The computer system comprises:

a product database (1) to store a set of products with properties which are assigned to the products;

a first memory area (4) to store the clusters for the search for union clusters;

a second memory area (5) to store clusters for which no conversion possibility exists; and

a computer program (3) to execute said method.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions, such as those expressing structural dimensions, quantities of ingredients, etc. used in the specification and claims are understood as modified in all instances by the term “about.”

### BRIEF DESCRIPTION OF THE DRAWINGS

FIG. 1 is a tabular representation of the structure of a database for storing properties of products of an assortment, in accordance with the method of the present invention;

FIG. 2 is a representative flowchart of a first embodiment of the method according to the present invention, which results in the output of a list of conversion possibilities;

FIG. 3 is a representative flowchart of a second embodiment of the present invention, in which assortment optimization is based on (or achieved by means of) a clustering method (or approach);

FIG. 4 is a representative flow-chart of a first embodiment of the clustering method of FIG. 3 (in particular with regard to looped steps 32 and 33 of FIG. 2);

FIG. 5 is a representative flow-chart of a second embodiment of the clustering method of FIG. 3 (in particular with regard to looped steps 32 and 33 of FIG. 2);

FIG. 6 is a graphic representation of a product assortment;

FIG. 7 is a graphic representation of the conversion possibilities of conversion candidates of the assortment of FIG. 6;

FIG. 8 is a graphic representation of the formation of clusters according to the method represented by the flow-chart of FIG. 4 in the product assortment of FIG. 6;

FIG. 9 is a graphic representation of the result of the assortment optimization of the assortment of FIG. 6 by the clustering of FIG. 8; and

FIG. 10 is a representative block diagram of a computer system for assortment optimization in accordance with the method of the present invention.

### DETAILED DESCRIPTION OF THE INVENTION

The invention allows computer-supported streamlining of an assortment by deleting products from the assortment according to specified, automatically evaluated criteria and replacing a deleted product by as similar a product from the assortment as possible. Another possibility of the assortment optimization according to the invention is that of creating new products, the properties of which lie between those of several existing products. One or more of the existing products are then converted to the new product. The computer program according to the invention can be used in such a way that it outputs proposals for the assortment optimization; on the basis of these proposals, a user can then make a decision about assortment optimization.

The basis of the computer-supported assortment optimization is a database in which the properties of products of the product assortment are stored. In the case of a plastic assortment, for instance, these include the following properties: type name, color number, color targets, type-related properties (mechanics, rheology, etc.), commercial properties (sales volume, turnover, number of customers, etc.), and other properties which can form the basis for formulation of conversion criteria.

According to a preferred embodiment of the invention, a data source in the form of, for example, a Microsoft Access database or Excel table is used as the database. The table includes, in each line, the property data about a product. For example, a typical table includes data such as: type name, color number, admixture; type-related properties: MVR (flowability), Vicat (thermoforming permanence), hardness, ISO-ak (impact value), contraction etc.; color targets in CIELAB color space, reflectance curves, color tolerances; and sales volume, turnover.

According to a preferred embodiment of the invention, to carry out automatic evaluations for assortment optimization, criteria for product conversions are given to the appropriate computer program on the basis of an assortment database. The program can be very flexible as far as the definition of such criteria on the basis of the existing data is concerned.

First, criteria which restrict the search space for the program are defined, by restricting the numbers of possible conversion candidates and targets in advance, on the basis of user's rules.

Conversion candidates: criteria according to which a product is considered as a conversion candidate are defined. The following are some examples of possible criteria. A conversion candidate may be any product with a sales volume <100 tonnes per year and ≦3 customers. A conversion candidate may be any product of which the type name begins with “X1” and which has an annual turnover of less than x. A conversion candidate may be any product with a negative DBII. “Deckungsbeitrag 2”

Conversion targets: criteria according to which a product is considered as a conversion target are defined. The following are some examples of possible criteria. A possible conversion target may be any product with a sales volume >100 tons per year and at least 3 customers. A possible conversion target may be any product of which the type name begins with “Y2”.

The program proposes a conversion from one product to another only if all the similarity criteria which the user has specified are fulfilled. For example, the user can specify that a conversion should only be possible if the hardness difference between the conversion candidate and the conversion target is less than 3 units.

It often happens that several property values are associated with each other, for example, the three values of a LAB color target. To be able to compare the colors of two products, the three color values of each product must be-considered as a vector with three components. Between the vectors of each product, a color distance is calculated as a Euclidean distance in three-dimensional space (i.e., as the square root of the sum of the squared individual distances).

To specify to the program that multiple parameters belong together, so-called blocks, to which multiple individual parameters can be assigned, are defined. For instance, the individual parameters L, A and B would be assigned to the LAB block for the color.

Combination as a block can also be meaningful for other data. For instance, a block “mechanics”, which combines multiple property data, such as impact value, flowability and hardness, can be defined. In this way a vector distance between two products in their mechanics can be calculated. Here too, a standard distance measurement such as the Euclidean distance is available. However, use of a different distance measurement for special tasks is also possible.

If a block contains parameters which have very different value ranges, the data of the individual parameters can be scaled to the interval [0 . . . 1], so that within a block all parameters contribute approximately equally to the total distance between the block vectors of two products.

Alternatively, the variance or the standard deviation of a parameter can be used for scaling. For this purpose, first the mean value of the parameter values of this parameter is formed, as well as the standard deviation or variance. The difference between the mean value and the standard deviation or variance then gives the lower interval limit, and adding the standard deviation or variance to the mean value correspondingly gives the upper interval limit. The value range of the relevant parameter is then normalised for instance, in such was a way that the lower interval limit is mapped to −1 and the upper interval limit to +1.

After the program has been informed by the definition of blocks about what data is to be used to determine distances (i.e., similarities), it is still necessary to define the maximum distance which is to be acceptable for the application. For each block, a value which must be undershot so that conversion from one product to another can be proposed is entered.

The invention also makes it possible to define conversion criteria referring to individual properties. For example, the following rules may be made (or applied). A product is a possible conversion target for a specified conversion candidate only if it has a greater sales volume than this conversion candidate. A product is a possible conversion target for a specified conversion candidate only if its production costs per kg are not more than 10 cents above those of the candidate.

According to a preferred embodiment of the invention, it is an aim of the evaluation to determine all associated possible conversion targets for each conversion candidate, and for instance to output them as a list. For example, the evaluation may take place using the following processing steps.

Determine all possible conversion candidates on the basis of the user's rules.

Determine all possible conversion targets on the basis of the user's rules.

For each possible conversion candidate.

Check each possible conversion target for whether the conversion candidate can be converted to this target according to the specified criteria.

Output each conversion candidate in a list, with the associated conversion possibilities which have been found.

The results list is structured in blocks. Each block contains one line with column titles. This is followed by a line in which the data of the conversion candidate is output. This line is highlighted in color. It is followed by one or more lines in which the appropriate conversion targets are listed with their data and with the block distances to the conversion candidate. Thus, for each conversion candidate, all alternative products in the assortment are clearly listed. Such a results list may then be used as the basis for decisions by the product managers.

Which property data is listed for each product in the results list is preferably adjustable, so that the results can be kept as clear as possible.

According to another preferred embodiment of the invention, a clustering method may be used, which is described in further detail as follows.

If all conversion possibilities are generated, the evaluation lists can be very long and unclear, depending on the set criteria. The invention therefore also makes it possible to select a series of conversions automatically from a large number of conversion possibilities, leading to a useful reduction of the whole assortment.

According to a preferred embodiment of the invention, it is therefore a goal of the evaluation to form so-called clusters. A cluster is a list of products which can be converted to a single product according to the specified conversion criteria.

The results list then looks at first glance similar to the case of the “conversion proposals” evaluation described above. Each listed cluster contains one line with column titles. This is followed by a line which is highlighted in color, and in which the data of the cluster center is output. The cluster center is a product which suggests itself as the conversion target for all other products in this cluster. These other products are listed in the following lines, with their data and the calculated similarity values to the cluster center.

Clusters are formed, for example, by the following step by step method. First, each individual product is considered as a cluster. At each processing step, a new cluster is formed by combining two existing clusters into one new one.

Now, at every processing step, there are often several possible ways of forming a new cluster. However, these possible ways are not equivalent. The aim at every step is to form a new cluster in which the included products are as similar as possible.

In the conversion criteria, the user has already made rules about what maximum (block) distances should apply between conversion candidate and conversion target (i.e., here cluster center). These settings are used to determine whether two clusters can be combined at all. To ensure the best possible quality of the new cluster, another rule must be made: What block distance should be decisive for the evaluation of a new cluster?

In an assortment, often a particular property (or property block) is particularly important in relation to combinations. In the case of plastics, these are typically the color properties. Products should then be combined in clusters in such a way that all similarity criteria are met. However, if there are multiple possibilities for combining products, the possibility which gives a new cluster with the colors which fit together as well as possible should be chosen. A program according to the invention makes it possible to select a property block for such prioritisation. However, depending on the application it is not necessarily color properties which are involved, but those properties in the assortment which are most critical for carrying out the conversions.

Alternatively, multiple distances with a specified weighting can be considered for the purposes of such prioritization.

A preferred embodiment of the clustering method according to the invention is described as follows.

Given: data and conversion criteria as described above, priority for a specified similarity value.

Set up a cluster list CL. CL includes.

(first) all individual products of the assortment

(later) individual products and product clusters.

Set up a cluster list EL. EL is initially empty, and later includes individual products and product clusters, which are no longer to be considered for further combinations.

For each product A of the list CL.

Is there any product B in CL to which all specified similarity limits are undershot? If not, delete product A from CL and add it to EL.

As long as CL includes at least two clusters:

Test all possibilities for combining two existing clusters in CL into a new cluster C. For this purpose, each possible cluster pair (A, B) is considered as follows:

Among the products in clusters A and B, is there a product Z which can be used as the cluster center for a new cluster C, so that all other products in A and B can be converted to product Z according to the specified criteria? If not, test next cluster pair.

If, in the case of a cluster pair, there are multiple possibilities for a new cluster center Z, the product which gives the least mean distance D of the individual products to Z in the prioritised similarity value is chosen for it.

The mean distance D of the individual products to Z in the prioritised similarity value is used to evaluate the quality of a possible new cluster.

From all found possibilities, form the new cluster with the best possible mean distance D of the individual products to Z. For this purpose, the two previous clusters A and B are removed from the list, and added to the list CL as a new cluster C.

Delete each cluster in CL for which there is no longer any possibility of combination with other clusters from CL, and add it to EL.

Output the results list EL, e.g., separated according to clusters and individual products. The clusters are sorted, e.g., according to the mean distance D of the individual products to the appropriate cluster center.

According to another preferred embodiment of the invention, a new product, the properties of which fulfil the conversion criteria with respect to all products of the union cluster, is defined as the cluster center of a union cluster. For conversion and assortment streamlining, therefore, not only are products which are already included in the assortment used, but also new products, which can replace several products of the assortment, are defined.

According to another preferred embodiment of the invention, the database with the property data of the products is on a server computer, which client computers can access, for example via an intranet.

In this way, the assortment optimization can be carried out in a decentralized way, by several users depending on product responsibility.

Below, preferred embodiments of the invention are explained in more detail, with reference to the drawings.

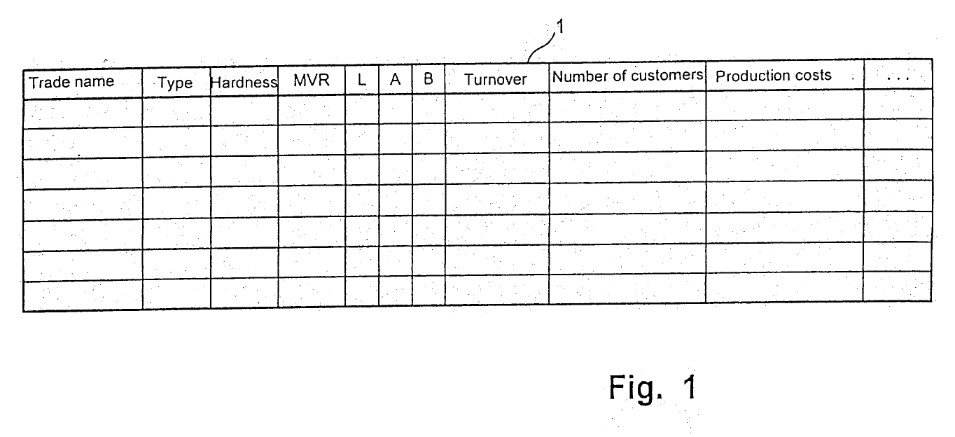

FIG. 1 shows a database 1 to store a product assortment. Each line in the database 1 refers to one product of the assortment, which is identified by its product designation, e.g., its trade name. One or more of the properties of the product with the trade name are stored in the appropriate line of the database entry of the database 1.

These properties can be, for instance, mechanical properties of the product, processing properties and processing parameters of the product and commercial properties. Examples of mechanical properties include, but are not limited to, ISO-ak (impact value) and hardness. Examples of processing-related properties include, but are not limited to, MVR (flowability), Vicat (thermoforming permanence) and contraction. Examples of commercial properties of the product include, but are not limited to, sales volume, turnover, number of customers and production costs.

A specially important property of a trade product is its color. To specify the color, the coordinates of the color of the plastic in a color space are used. For instance, the LAB coordinates of the CIELAB color space can be used. Regarding the color, it is also advantageous to give a color number, color tolerances and if appropriate reflectance curves.

Additionally, for each product, the database 1 includes the type as well as the trade name. The type data identifies certain special properties of the relevant trade product. For example, the types distinguish between “well flowing”, “heat-stabilized”, “medium viscous”, “additionally nucleated”, “weather-stabilized”, “more viscous”, “with glass fiber”, “flame-retarding”, etc.

Because of the many variation possibilities, particularly the type-color combinations, the database 1 of a plastic product assortment can include several hundred to several thousand different products.

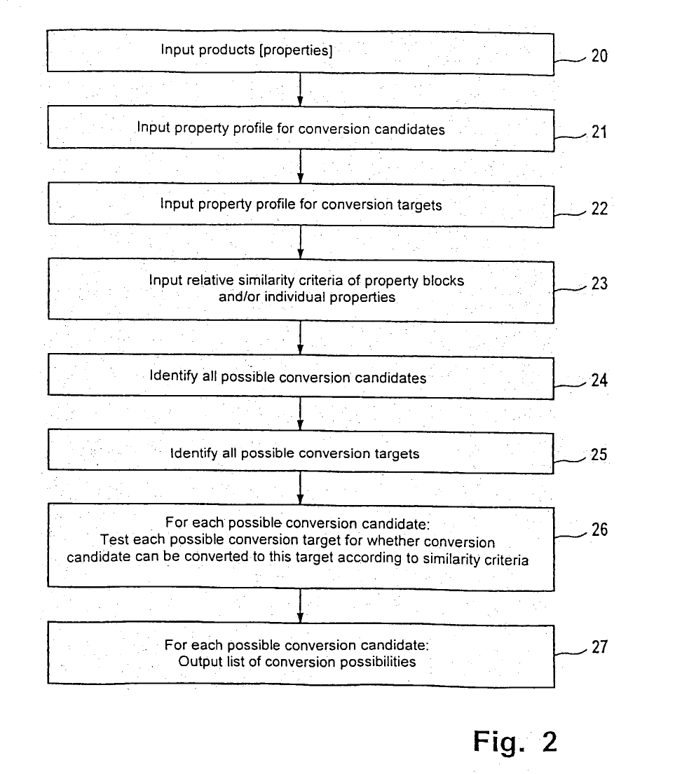

FIG. 2 shows an embodiment of the method according to the invention for computer-supported assortment optimization, for example a plastic product assortment, such as is stored in the database 1 of FIG. 1.

In Step 20, the products of the product assortment are entered, with the properties which are assigned to the products. The result is a database, for instance in the form of the database 1 of FIG. 1.

In Step 21, a property profile for conversion candidates is entered. “Conversion candidate” here means a product which is considered for assortment streamlining, i.e., conversion to a different product. To be considered as a conversion candidate at all, the relevant product must fulfil a property profile which the user can define. Such a property profile may consist of one or more properties.

In Step 22, a property profile for conversion targets is entered. “Conversion target” here means a product of the product assortment which is considered as a substitute for a conversion candidate. A conversion target is therefore a product which can replace one or more of the products of the assortment, because it is sufficiently similar to these products.

To be considered as a conversion target at all, the relevant product must fulfil a property profile. This property profile is definable by the user, and includes one or more properties which the product must fulfil to be classified as a conversion target.

In Step 23, relative similarity criteria between property blocks or individual properties are entered. These must be fulfilled for a conversion candidate to be classified as sufficiently similar to a conversion target. The property blocks combine multiple properties, such as the color co-ordinates, or other properties which belong to a common category.

In Step 24, a database search in the database 1 (e.g., FIG. 1) is started with the property profile of Step 21 as the search criterion, to determine all possible conversion candidates of the database 1 which correspond to the property profile. In Step 25, a search for the conversion targets in the database 1 takes place, the property profile of Step 22 being used as the search parameter.

In Step 26, for one of the conversion candidates, there is a test for whether one of the conversion targets which were identified in Step 25 fulfils the similarity criteria of Step 23. If this is the case, the relevant conversion target is an actual conversion possibility.

This test is repeated with respect to this conversion candidate for each conversion target, so as to come if possible to a number of conversion possibilities for the conversion candidate. Step 26 is carried out with reference to each of the conversion candidates which were identified in Step 24, so as to come to one or more conversion possibilities, or none, for each conversion candidate.

In Step 27, these conversion possibilities are output, for example, in the form of a list for each conversion candidate. These lists preferably also include the relevant properties of the conversion possibilities, to choose a selection from the list for conversion of the conversion candidate to a product from the list of conversion possibilities.

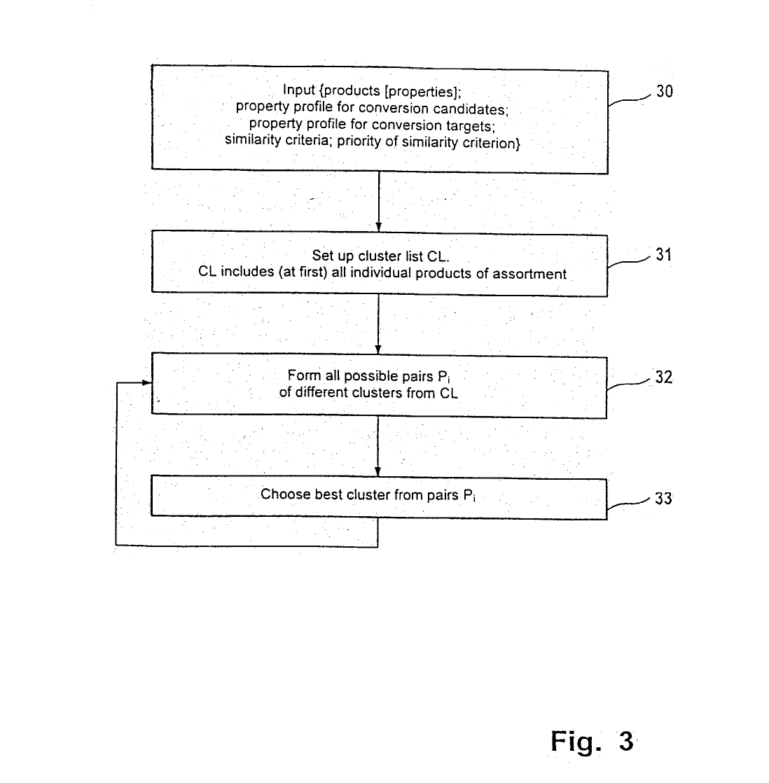

FIG. 3 shows a flowchart of another embodiment of the invention, to streamline an assortment by a clustering method.

In Step 30, products with their properties, a property profile for conversion candidates, a property profile for conversion targets, and similarity criteria (e.g., Steps 20, 21, 22 and 23 of FIG. 2) are entered. Additionally, a priority is assigned to one of the similarity criteria. This similarity criterion with a priority is decisive for determining the quality of a clustering.

In Step 31, a cluster list CL is set up. The cluster list CL includes all individual products of the assortment, a separate cluster being defined by each individual product. These product clusters, with one product each at first, are subsequently combined if possible by the clustering method according to the invention.

In Step 32, all possible pairs Pᵢ of different clusters of the cluster list CL are formed. For each of the pairs Pᵢ, there is then a test for whether the union of the clusters of the pair is possible, taking account of the property profiles and similarity criteria. If there are different possibilities for forming union clusters, one possibility is chosen in Step 33, so that the relevant pair Pᵢ of clusters is combined into a union cluster. The clusters of the pair Pᵢ are deleted from the cluster list CL. The union cluster which includes the products of the clusters of the pair Pᵢ is newly added to the cluster list CL.

Steps 32 and 33 are then carried out again with reference to the changed cluster list CL, to achieve a further union of clusters and a corresponding change to the cluster list CL. By forming union clusters with corresponding cluster centers, in this way the product assortment is streamlined step by step.

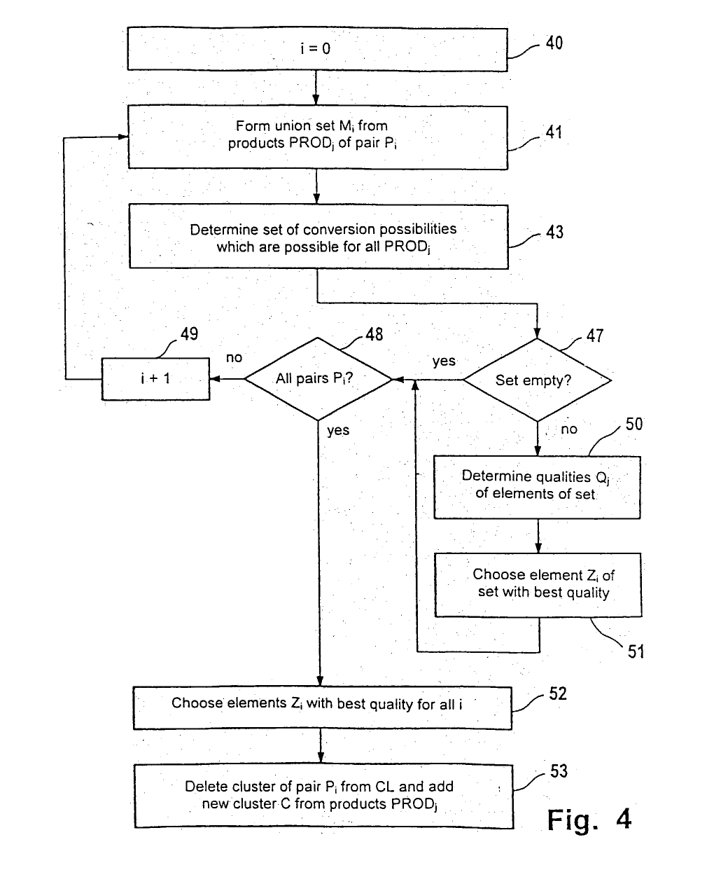

FIG. 4 shows an embodiment of the clustering method according to the invention to carry out Steps 32 and 33 of FIG. 3.

In Step 40, the index i of the possible pairs Pᵢ is set equal to zero. In Step 41, the union set Mᵢ of the products which are included in the clusters of the pair Pᵢ is formed. The union set Mᵢ then consists of the products PRODⱼ.

In Step 43, the set of conversion possibilities which are possible for all PRODⱼ as conversion candidates is determined. This means that only those conversion possibilities which represent conversion possibilities for all products PRODⱼ of the union set Mᵢ are added to the set of conversion possibilities in Step 43. The test for whether a conversion possibility exists for a given PRODⱼ, as a conversion candidate, can be carried out according to the sequence of FIG. 2.

In Step 47, there is a test for whether the set of conversion possibilities which has been determined in Step 43 is the empty set. If this is the case, in Step 48 there is a test for whether all possible pairs of clusters Pᵢ have already been processed. If this is not the case, in Step 49 the index i is incremented, followed by a branch to Step 41. Steps 41 to 48, and Steps 50 and 51 if appropriate, are then repeated with reference to the next pair Pᵢ.

If the result of the test in Step 47 has been that the set of conversion possibilities is not the empty set, Step 50 is executed. In Step 50, the qualities Qⱼ of the elements of the set of conversion possibilities are determined. To determine the quality, the similarity criterion to which the priority has been assigned (e.g., Step 30 of FIG. 3) is used. This similarity criterion can be, for instance, similarity of the colors of the products which are being considered.

To reach a numerical statement about the quality Qⱼ, the procedure can be as follows: The distances from a property block of an element of the set of conversion possibilities (e.g., the “color” property block) and the corresponding property blocks of the product PRODⱼ are formed, and, for example, the arithmetic mean of these distances is calculated. This arithmetic mean is the quality Qⱼ of that element of the set of conversion possibilities which is being considered. If this set of conversion possibilities has more than one element, the quality is calculated in this way for each of the elements of the set of conversion possibilities.

In Step 51, that element Zᵢ of the set of conversion possibilities which has the best quality is chosen. Step 48 is then executed. If it is found in Step 48 that all pairs Pᵢ have already been processed, Step 52 is executed. In Step 52, the elements Zᵢ which have been identified for the various pairs Pᵢ are compared to each other, and the element Zᵢ with the best quality of all these elements is chosen.

In Step 53, the pair of clusters Pᵢ which belongs to this overall best element Zᵢ is deleted from the cluster list CL, and the union cluster is formed from the cluster pair Pᵢ. This union cluster includes the products PRODⱼ of the union set Mᵢ of the relevant pair Pᵢ. The new union cluster which is determined in this way is added to the cluster list CL.

For the modified cluster list CL, all possible pairs Pᵢ of different clusters are again formed (cf. Step 32 of FIG. 3). Steps 40 to 53 are then executed again with reference to the newly identified pairs Pᵢ, to come to a further union of clusters. This method is, for instance, continued until no further union clusters can be formed. The assortment streamlining is then concluded.

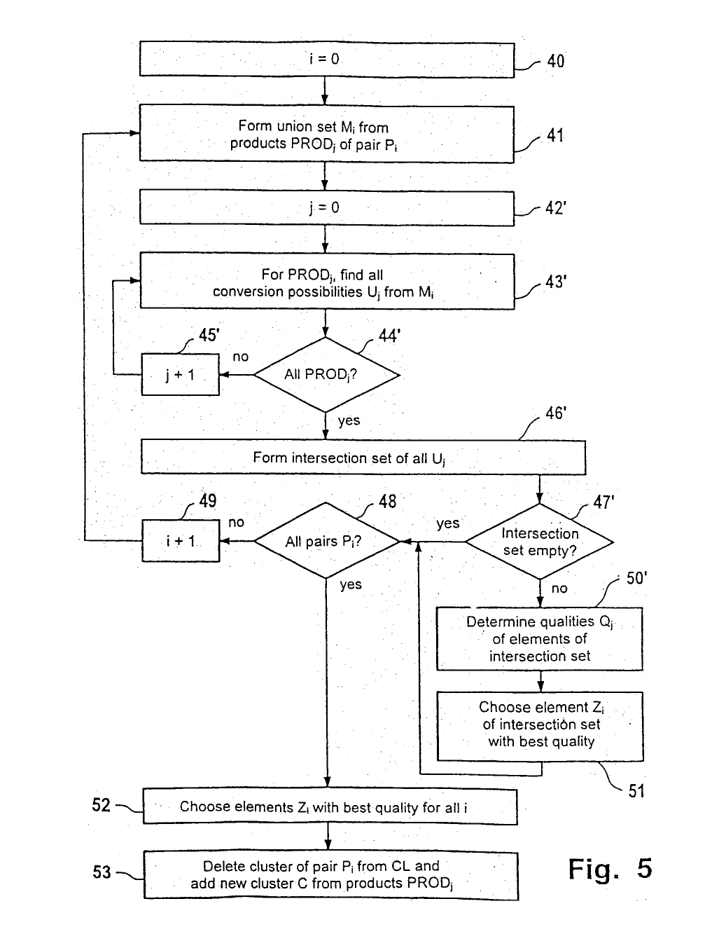

FIG. 5 shows an alternative embodiment of the clustering method according to the invention to carry out Steps 32 and 33 of FIG. 3. Steps 40, 41 and Steps 48 to 53 are identical to the corresponding steps of FIG. 4. On the other hand, Steps 42′ to 51′ of the method of FIG. 5 form an alternative implementation for determining and evaluating the set of conversion possibilities:

In Step 42′, the index j of the products PRODⱼ of the union set Mᵢ is set to zero.

In Step 43′, for the product PRODⱼ of the union set Mᵢ, all conversion possibilities Uⱼ to conversion targets in the set Mᵢ are determined. This takes place according to the method of FIG. 2 (i.e., the product PRODⱼ must fulfil the property profile for a conversion candidate) a conversion target which corresponds to the specified property profile must be determined, and the similarity criteria between the product PRODⱼ and the permitted conversion targets must be fulfilled, to reach a conversion possibility Uⱼ. The result of Step 43′ is therefore one or more conversion possibilities Uⱼ, or none, for the product PRODⱼ as conversion candidates, both the product PRODⱼ and the conversion possibilities Uⱼ if any being part of the set Mᵢ.

In Step 44′, there is a test for whether all products PRODⱼ have been processed in this way. If this is not the case, in Step 45′ the index j is incremented, and Step 43′ is executed for the next product PRODⱼ, to reach conversion possibilities Uⱼ for this product. Steps 43′, 44′ and 45′ are therefore executed until all products PRODⱼ of the union set Mᵢ have been processed.

Then, in Step 46′, the intersection set of all conversion possibilities Uⱼ is formed. This intersection set therefore includes those conversion possibilities which apply to all products PRODⱼ of the union set Mᵢ.

In Step 47′, there is a test for whether this intersection set is empty. If this is the case, in Step 48 there is a test for whether all possible pairs of clusters Pᵢ have already been processed. If this is not the case, in Step 49 the index i is incremented, followed by a branch to Step 41. Steps 41 to 48, and Steps 50′ and 51′ if appropriate, are then repeated with reference to the next pair Pᵢ.

If the result of the test in Step 47′ has been that the intersection set is not empty, Step 50′ is executed. In Step 50′, the qualities Qⱼ of the elements of the intersection set are determined. To determine the quality, the similarity criterion to which the priority has been assigned (e.g., Step 30 of FIG. 3) is used. This similarity criterion can be, for instance, similarity of the colors of the products which are being considered.

To reach a numerical statement about the quality Qⱼ, the procedure may be as follows. The distances from a property block of an element of the intersection set (e.g. the “color” property block) and the corresponding property blocks of the product PRODⱼ are formed, and, for instance, the arithmetic mean of these distances is calculated. This arithmetic mean is the quality Qⱼ of that element of the intersection set which is being considered. If this intersection set has more than one element, the quality is calculated in this way for each of the elements.

In Step 51′, that element Zᵢ of the intersection set which has the best quality is chosen. Step 48 is then executed.

If it is found in Step 48 that all pairs Pᵢ have already been processed, Step 52 is executed. In Step 52, the elements Zᵢ which have been identified for the various pairs Pᵢ are compared to each other, and the element Zᵢ with the best quality of all these elements is chosen.

In Step 53, the pair of clusters Pᵢ which belongs to this overall best element Zᵢ is deleted from the cluster list CL, and the union cluster is formed from the cluster pair Pᵢ. This union cluster includes the products PRODⱼ of the union set Mᵢ of the relevant pair Pᵢ. The new union cluster which is determined in this way is added to the cluster list CL.

For the modified cluster list CL, all possible pairs Pᵢ of different clusters are again formed (e.g., Step 32 of FIG. 3). Steps 40 to 53 are then executed again with reference to the newly identified pairs Pᵢ, to come to a further union of clusters. This method is, for example, continued until no further union clusters can be formed. The assortment streamlining is then concluded.

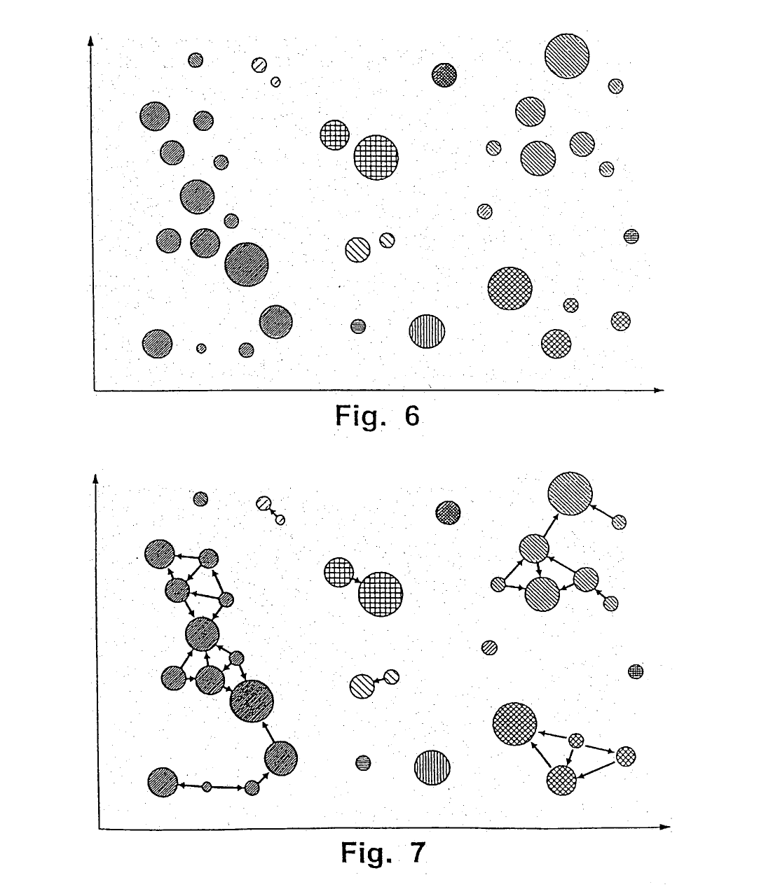

FIG. 6 shows a graphic representation of a product assortment. Each circle in the graphic representation of FIG. 6 symbolizes a single product of the product assortment. The position of the circle in the diagram is determined by the color co-ordinates of the relevant product. The diameter of the circle is proportional to the sales volume.

On this basis, products with similar colors are spatially close to each other, and products with large sales volume are shown larger than products with small sales volume. The aim is to streamline this assortment and, in the case of products which are deleted from the assortment, to convert the customers to as similar a product as possible.

For example, the following conversion criteria may be defined; products with a small sales volume should be converted to products with a larger sales volume; and a specified color difference (color distance) must not be exceeded.

FIG. 7 shows the result of applying the method of FIG. 2. Each arrow connects a conversion candidate to a conversion possibility in the direction of the arrow.

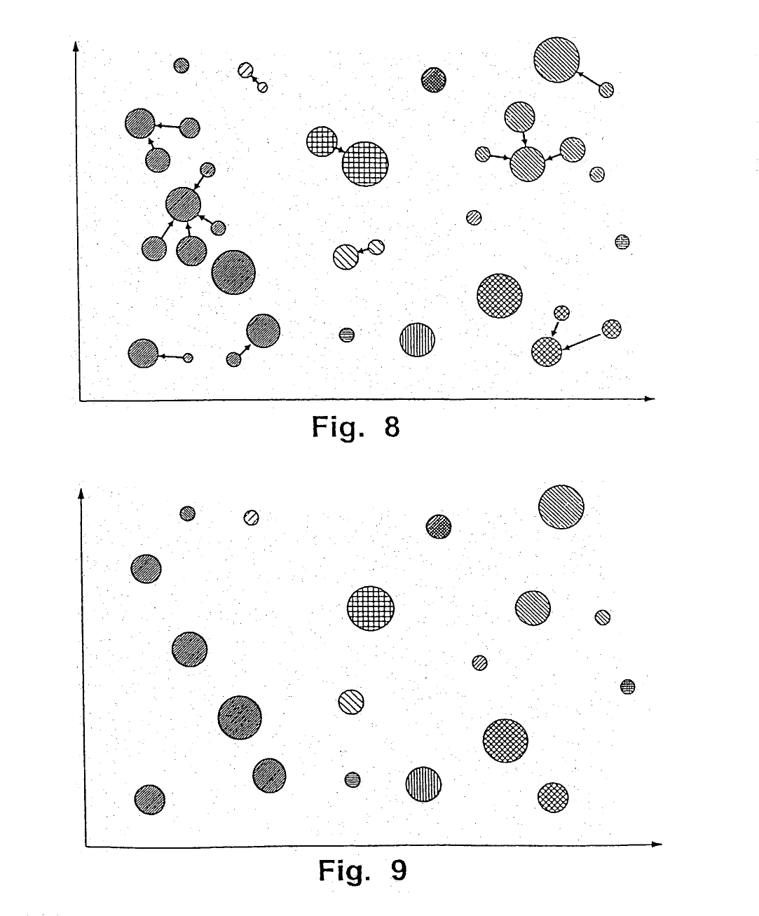

FIG. 8 illustrates the result of applying the methods of FIGS. 3 and 4 or 5 to the product assortment of FIG. 6. The arrows indicate combination into union clusters. The result of this clustering is that for each conversion candidate only a maximum of one conversion target is given.

FIG. 9 shows the result of clustering according to FIG. 8. The result of the evaluation is a closed scenario for an optimised product assortment.

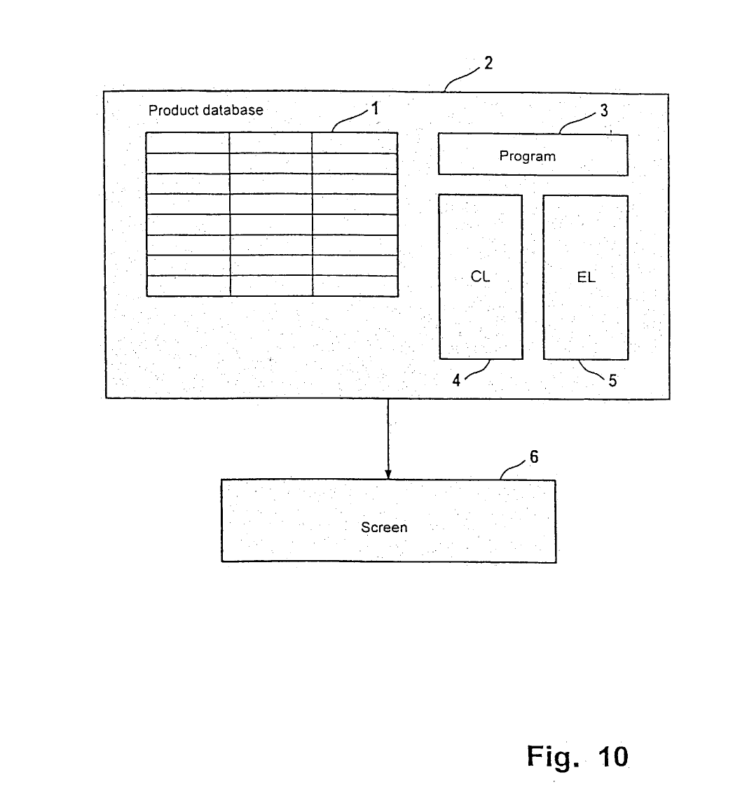

FIG. 10 shows a computer system 2 with a product database 1 (e.g., FIG. 1), a program 3 and the memory areas 4 and 5. A screen 6 is connected to the computer system 2.

The program 3 has two different processing modes. One processing mode corresponding to the method of FIG. 2, and another processing mode corresponding to the method of FIGS. 3 and 4 or 5, depending on whether the user wants an output of multiple conversion possibilities or a clustering.

For the case of clustering, the cluster list CL is stored in the memory area 4. The memory area 5 is used to store another cluster list EL. The cluster list EL is empty at first. As clustering progresses, the cluster list EL later includes individual products and product clusters which are no longer considered for further combination.

### REFERENCE SYMBOL LIST (FOR FIG. 10)

Database 1

Computer system 2

Program 3

Memory area 4

Memory area 5

Screen 6

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of computer-supported assortment optimization comprising the steps of:
(a) inputting a first property profile for conversion candidates;
(b) inputting a second property profile for conversion targets;
(c) inputting at least one similarity criterion of at least one property of two comparable products of an assortment;
(d) identifying, from the assortment,
(i) all conversion candidates which correspond to said first property profile, and
(ii) all conversion targets which correspond to said second property profile;
(e) testing, for each conversion candidate, each of the conversion targets to determine whether said at least one similarity criterion is fulfilled, thereby identifying a conversion possibility for each conversion candidate; and
(f) outputting a set of conversion possibilities for each of said conversion candidates.

2. The method of claim 1 wherein at least one member of the group consisting of a material-specific property, a processing-specific property, a color property and a commercial property, is assigned to each product.

3. The method of claim 1 further comprising, combining at least two properties into a property block, and using said property block as a basis for said similarity criterion.

4. The method of claim 3 wherein a Euclidean distance between same property blocks of two comparable products forms the basis for said similarity criterion.

5. The method of claim 3 further comprising normalizing the properties of said property block to a common value range.

6. The method of claim 1 further comprising outputting a list of conversion possibilities for each conversion candidate, wherein said list of conversion possibilities includes at least one property of each conversion possibility.

7. The method of claim 1, further comprising the steps of:
forming a separate cluster for each product of said assortment;
forming all possible pairs of said clusters that are different one from the other; and
combining one of the possible pairs into a union cluster, the union cluster having a cluster center, which is a conversion possibility for all products of a union set of the pair of clusters.

8. The method of claim 7 further comprising the steps of:
forming a union set (Mᵢ) of products (PRODⱼ) of a possible pair;
identifying all conversion possibilities (Uⱼ) of comparable products of the union set for each of the products;
forming an intersection set of conversion possibilities; and
selecting a product (Zᵢ) from the intersection set as the cluster center of the union cluster.

9. The method of claim 8 wherein a quality (Qⱼ) of the conversion possibilities of the intersection sets is taken into account for selecting the product as the cluster center of the union cluster.

10. The method of claim 9 wherein said quality is determined with respect to one of a prioritized property and a prioritized property block.

11. The method of claim 7 wherein the set of clusters which are considered for the search for conversion targets are purged of those clusters for which there is no conversion possibility on the basis of the second property profile.

12. The method of claim 7 wherein said cluster center for said union cluster is identified as a new product in such a way that the new product fulfils the similarity criteria with respect to all products of a relevant union cluster.

13. The method of claim 1 further comprising providing a computer program to execute said method.

14. The method of claim 12 further comprising providing a computer system having resources to execute said method.

15. The method of claim 14 wherein said computer system comprises:
a product database (1) to store a set of products with properties which are assigned to the products;
a first memory area (4) to store the clusters for the search for union clusters;
a second memory area (5) to store clusters for which no conversion possibility exists; and
a computer program (3) to execute said method.
